(19) United States
(12) Patent Application Publication
(10) Pub. No.: US 2025/0257166 A1
(43) Pub. Date: Aug. 14, 2025

(54) ETHYLENICALLY UNSATURATED POLY(PHTHALALDEHYDE) POLYMERS, COMPOSITIONS AND METHODS

(71) Applicant: 3M INNOVATIVE PROPERTIES COMPANY, St. Paul, MN (US)

(72) Inventors: Carl A. Laskowski, Minneapolis, MN (US); Paul B. Armstrong, St. Paul, MN (US); Austin G. Kruger, St. Paul, MN (US)

(21) Appl. No.: 18/859,214

(22) PCT Filed: Jul. 17, 2023
(86) PCT No.: PCT/IB2023/057286

§ 371 Date: Oct. 23, 2024

Related U.S. Application Data
(60) Provisional application No. 63/398,919, filed on Aug. 18, 2022.

(51) Int. Cl. C08F 290/06; C08G 4/00; C09D 151/08

(52) U.S. Cl. CPC C08F 290/06; C08G 4/00; C09D 151/08

(57) ABSTRACT

Poly(phthaladialdehyde) polymers are described comprising the reaction product of an intermediate comprising the reaction product of phthaladialdehyde and a polyol; and an end-capping compound comprising an ethylenically unsaturated group. Also described are composition comprising the poly(phthaladialdehyde) polymer and at least one other ethylenically unsaturated component.

### BACKGROUND

As described in DiLauro A. et al., (2013) “Reproducible and Scalable Synthesis of End-Cap-Functionalized Depolymerizable Poly(phthalaldehydes)”, Macromolecules 46, 2963-2968, poly(phthalaldehyde) is known to depolymerize continuously from one end to the other. The polymer terminated with acetal has a ceiling temperature of −40° C., whereas the end-capped polymer is meta-stable up to 150° C.

### SUMMARY

Although some end-capped poly(phthalaldehyde) polymers have been described, industry would find advantage in other end-capped poly(phthalaldehydes).

In one embodiment, a poly(phthaladialdehyde) polymer is described comprising the reaction product of an intermediate comprising the reaction product of phthaladialdehyde and a polyol; and an end-capping compound comprising an ethylenically unsaturated group. Utilizing a polyol in the synthesis can provide two or more poly(phthalaldehyde) segments covalently bonded by the reacted polyol. This intermediate can be reacted with one or more end-capping compounds, at least one of which comprises an ethylenically unsaturated group.

In some favored embodiments, the poly(phthaladialdehyde) polymer averages at least two or three ethylenically unsaturated groups. Advantageously, poly(phthalaldehyde) comprising two or more ethylenically unsaturated groups can be utilized as crosslinkers in free-radically polymerizable (e.g. actinic radiation curable) compositions.

In some embodiments, the poly(phthaladialdehyde) polymer has the formula:

R³-[PPA-L¹-R¹]ₙ
wherein R³ is a residue of a polyol;
PPA is poly(phthaladialdehyde);
L¹ is independently a covalent bond or a linking group:
n is at least 2; and
R¹ is independently an end group such at least two R¹ groups are ethylenically unsaturated groups.

In some embodiments, the poly(phthaladialdehyde) polymer is a copolymer comprising polymerized unit of a second aldehyde that is not phthaladialdehyde. The presence of a second aldehyde can be utilized to adjust the physical properties, such as glass transition, toughness, and solubility in organic solvents.

In some embodiments, the poly(phthaladialdehyde) polymer has the formula:

R³-[PPA/A²-L¹-R¹]ₙ
wherein R³ is a residue of a polyol;
PPA/A² is a copolymer of poly(phthaladialdehyde) and a second different aldehyde (i.e. A²);
L¹ is independently a covalent bond or a linking group;
n is at least one; and
R¹ is independently an end group such that one or more R¹ groups are ethylenically unsaturated groups.

In other embodiments, polymerizable compositions are described comprising the ethylenically unsaturated poly(phthaladialdehyde) polymer described herein and at least one other ethylenically unsaturated component.

In another embodiment, a method of making poly(phthaladialdehyde) polymer is described comprising:
anionic polymerizing phthaldialdehyde with a polyol co-initiator to provide an intermediate having the formula

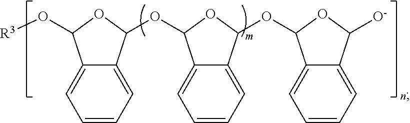

and
reacting the oxygen anion with an end-capping compound comprising an electrophilic group and an ethylenically unsaturated group.

The end-capped poly(phthalaldehydes) and polymerizable composition described herein can be used in recyclable plastics as well as radiation-sensitive or heat-sensitive degradable film, e.g. for lithography.

### DETAILED DESCRIPTION

Presently described are polyaldehyde polymers and copolymers comprising ethylenically unsaturated groups. The polyaldehyde comprises a polymerized (e.g. repeat) unit comprising an (e.g. aromatic) cyclic group, most typically phthaldialdehyde.

Any suitable method can be used to synthesize the ethylenically unsaturated poly(phthalaldehydes) described herein.

In one embodiment, the method of making the poly(phthaladialdehyde) polymer comprises
(e.g. anionic) polymerizing ortho-phthaldialdehyde with a polyol to provide an intermediate having the formula:

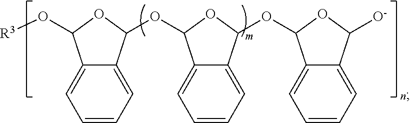

and
reacting the oxygen anion with an end-capping compound comprising an electrophilic group (e.g. an acid chloride, anhydride, or isocyanate) and an ethylenically unsaturated group.

The phthalaldehyde may comprise or consist of ortho-phthalaldehyde, depicted as follows:

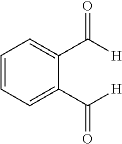

In some embodiments, the (e.g. ortho) phthalaldehyde has a purity of at least 90, 91, 92, 93, 94, 95, 96, 97, 98, 99% or greater.

Various polyols can be utilized in the synthesis. Polyols are readily commercially available. When depolymerizing the poly(phthaladialdehyde) polymer, the polymerized polyol can assist in removal. In some embodiments, the depolymerized end-product may be liquid rather than solid. By use of a polyol high yields can be obtained in the absence of purifying the poly(phthaladialdehyde) polymer, In some embodiments, the yield of the poly(phthaladialdehyde) polymer is at least 60, 65, 70, 75, 80, 85, 90, or 95% or greater.

Polyols are aliphatic or aromatic compounds comprising at least two hydroxyl groups. Typical polyols comprise no greater than 24 carbon atoms. In some embodiments, the polyol comprises no greater than 11, 10, 9, 8, 7, 6, 5, 4, or 2 carbon atoms.

In some embodiments, the polyols are diols. In other embodiments, the polyol comprises at least three (i.e. triols) or four hydroxyl groups (i.e. tetraols), such as in the case of glycerol or pentaerythritol.

In some embodiments, the diol further comprises a heteroatom, such as oxygen, between the hydroxyl groups such as in the case of dialkylene glycol ether diols (e.g. diethylene glycol ether diol). Thus, the polyol may also be ether polyols or polyether polyols.

Common polyols, such as those used in the synthesis of polyurethane, include for example C2-C6 diols such as ethylene glycol, diethylene glycol, triethylene glycol, tetraethylene glycol, propylene glycol, dipropylene glycol, tripropylene glycol; 1,3-propanediol; 1,3-butane diol; neopentyl glycol; 1,6-hexanediol; and 1,4-cyclohexanedimethanol; C2-C6 triols such as glycerol, trimethylol propane, and 1,2,6-hexanetriol; as well as tetraols such pentaerythritol.

One representative aromatic diol is hydroquinone bis(2-hydroxyethyl) ether (HQEE) having the following structure:

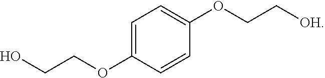 [SMILES: OCCOc1ccc(OCCO)cc1]

Diphenyl and benzyl polyols are also commercially available. Representative compounds include for example 2-benzyl-1,3-propanediol, 5-benzyl-3-phenoxybenzene-1,2-diol, bisphenols, ethoxylated bisphenol, propoxylated bisphenols, and bis(hydroxypropyl)bisphenols.

Anionic polymerizations are conducted in a relatively non-polar organic solvent such as tetrahydrofuran (THF), diethyl ether, dimethoxyethane, dichloromethane, benzene, toluene, or mixtures thereof.

The solvent and polyol are selected such that phthalaldehyde, optional second aldehydes(s), and the polyol are miscible in the solvent under relevant polymerization conditions. The reaction temperature typically ranges from −70 to −100° C. (e.g. −78° C., −90° C.). Polyols comprising nitrogen atoms (e.g. amine moieties) are typically not suitable.

The anionic polymerizations typically utilize catalysts that are basic compounds. Typical anionic polymerization catalysts include amides, aryls, alkoxides, phosphines, and organometallic compounds (alkyllithium compounds and Grignard reagents). The polymerization of ortho-phthalaldehyde is preferentially completed in the presence of an oxy-anion derived from a strong base and alcohol. The multifunctional poly(phthaldialdehyde) described here is prepared from the representative polyols listed above and an inorganic, organic, or organometallic base of sufficient basicity. Useful basic catalysts for the polymerization of poly(phthaldialdehyde) include phosphazene “super-bases” such as “Verkade's bases” (e.g. 2,5,8,9-Tetraaza-1-phosphabicyclo[3.3.3]undecane-2,8,9-tris(1-methylethyl)), “P2” (1-tert-Butyl-2,2,4,4,4-pentakis (dimethylamino)-2λ⁵,4λ⁵-catenadi(phosphazene) and “P4” (1-tert-Butyl-4,4,4-tris(dimethylamino)-2,2-bis[tris(dimethylamino)-phosphoranylidenamino]-2λ⁵,4λ catenadi(phosphazene), metal alkoxides (e.g. LiO^{t}Bu), and naphthalide (as described by Tagami et. al. in Macromolecules, 1969, 2, pg. 414).

The polyol may be characterized as a co-initiator. As depicted in the reaction scheme of the examples, the polyol covalently bonds two of more segments of poly(phthalaldehydes). In typical embodiments, the molecular weight of the reacted polyol (i.e. the residue of a polyol) is low as compared to the molecular weight of the poly(phthalaldehyde). As demonstrated by the thermogravimetric properties described in the examples, when residue of the polyol is of sufficiently low molecular weight, the presence thereof does not detract from the depolymerization properties (e.g. onset of thermal degradation and loss of mass) of the poly(phthalaldehydes).

An intermediate formed by the (e.g. anionic) polymerization of phthalaldehyde and a polyol may be represented by the formula:
R³[PPAO⁻]ₙ or

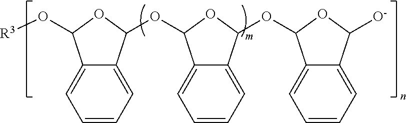

wherein R³ is a residue polyol;
PPA is poly(phthalaldehyde); and
n is the number of hydroxyl groups of the polyol.
The term residue refers to a group of atoms considered as a part of the polyol. The polyol residue typically has the same structure as the polyol reactant except that the terminal hydrogen atoms of the hydroxyl groups have been removed during the polymerization process.

In some embodiments, n is at least 2, 3 or 4; as previously described.

In some embodiments, a second aldehyde that is different than phthalaldehyde can be included in the (e.g. anionic) polymerization.

Aldehydes include for example formaldehyde (including paraformaldehyde), acetaldehyde (including paraacetaldehyde), propionaldehyde, butyraldehyde, n-octylaldehyde, amylaldehyde, hexylaldehyde, heptylaldehyde, 2-ethylhexylaldehyde, cyclohexylaldehyde, furfural, glyoxal, glutaraldehyde, benzaldehyde, 2-methylbenzaldehyde, 3-methylbenzaldehyde, 4-methylbenzaldehyde, p-hydroxybenzaldehyde, m-hydroxybenzaldehyde, phenylacetaldehyde, β-phenylpropionaldehyde, and the like. Esters of glyoxylic acid such as ethyl glyoxylate, propyl glyoxylate, butyl glyoxylate, pentyl glyoxylate, hexyl glyoxylate, octyl glyoxylate, and phenyl glyoxylate may also be included. These aldehydes may be used singly or in combination of two or more.

An intermediate formed by the (e.g. anionic) polymerization of phthalaldehyde, a second different aldehyde, and a polyol may be represented by the formula:

R³[PPA/A²]ₙ
wherein R³ is a residue of a polyol;
PPA/A² is a copolymer of poly(phthalaldehyde) and a second aldehyde (A²); and
n is at least one.

Additional copolymers can be represented by additional A groups, wherein each superscript corresponds to a different aldehyde. (e.g. PPA/A²/A³)

The amount of phthalaldehyde and second aldehyde can vary. In typical embodiments, the amount by weight of phthalaldehyde is greater than or equal to the second aldehyde. The weight ratio of phthalaldehyde to second aldehyde can range from 1:1 to 10:1. In some embodiments, the weight ratio of phthalaldehyde to second aldehyde is at least 1.1:1, 1.2:1, 1:3:1, 1.4:1, 1.5:1, 1.6:1, 1.7:1, 1.8:1, 1.9:1, or 2:1. In some embodiments, the weight ratio of phthalaldehyde to second aldehyde is at least 3:1, 4:1, 5:1, 6:1, 7:1, 8:1, 9:1 or 10:1. Copolymers with sufficiently high concentrations of phthalaldehyde can have similar depolymerization properties as poly(phthalaldehyde) homopolymer. However, other properties can be modified by inclusion of other aldehydes.

Phthalaldehyde copolymers, wherein n is 1, or in other words comprising a single ethylenically unsaturated group can be prepared by utilizing pyridine and ally chloroformate, such as described in previously cited DiLauro A. et al.

In some favored embodiments, n is two or more as previously described.

The intermediate is reacted with one or more end-capping compounds. At least one of the end-capping compounds comprises an electrophilic group (that reacts with the oxygen anion of PPA) and an ethylenically unsaturated group. The ethylenically unsaturated group is typically a (meth)acrylate group or a vinyl group. The ethylenically unsaturated group is typically not a (meth)acrylamide due to the difficulty in synthesizing an acrylamide with a free electrophilic group for substitution. Suitable end-capping compounds include for example compounds having a halogenated carbonyl group such as methacryloyl halide (e.g. chloride), methacryloyl isocyanates (e.g. IEM), and acid anhydride (e.g. methacrylic anhydride). In some embodiments, acid anhydrides result in lower yields.

In some embodiments, a single end-capping compound comprising an ethylenically unsaturated group is utilized. In some embodiments, at least two different end-capping compounds are utilized wherein both of the end-capping compounds comprise an ethylenically unsaturated group.

In yet another embodiments, at least two different end-capping compounds are utilized wherein at least one of the end-capping compounds comprises an ethylenically unsaturated group and at least one the end-capping compounds lack an ethylenically unsaturated group.

When an end-capping compound comprising an ethylenically unsaturated group is utilized in combination with an end-capping compound comprising a non-reactive end group, there is a statistical distribution of the end-groups typically based on the amount of the non-reactive end group. For example, when half of end-capping compound, on a molar basis, comprises an end-capping compound comprising an ethylenically unsaturated group and the other half comprises an end-capping compound comprising a non-reactive end group, about half of the end groups will comprise a non-reactive end group. Statistically about half of the poly(phthalaldehyde) chains would be expected to have one terminal ethylenically unsaturated group and an opposing terminal non-reactive group.

The molar ratio of end-capping compound comprising an ethylenically unsaturated group to end-capping compound lacking an ethylenically unsaturated group (e.g. having a non-reactive end group) can range from 10:1 to 1:10. For embodiments wherein the poly(phthalaldehyde) comprises at least two terminal ethylenically unsaturated groups, typically the molar amount of end-capping compound comprising an ethylenically unsaturated group is greater than the end-capping compound lacking an ethylenically unsaturated group (e.g. having a non-reactive end group). Thus the molar ratio is typically greater than 1:1. In some embodiments, the molar ratio comprising an ethylenically unsaturated group to end-capping compound lacking an ethylenically unsaturated group (e.g. having a non-reactive end group) is at least 1.1:1, 1.2:1, 1:3:1, 1.4:1, 1.5:1, 1.6:1, 1.7:1, 1.8:1, 1.9:1, or 2:1. In some embodiments, the molar ratio is at least 3:1, 4:1, 5:1, 6:1, 7:1, 8:1, 9:1 or 10:1.

Other suitable end-capping compounds that lack or comprise ethylenically unsaturated groups are known in the art. Some representative end-capping compounds are depicted as follows:

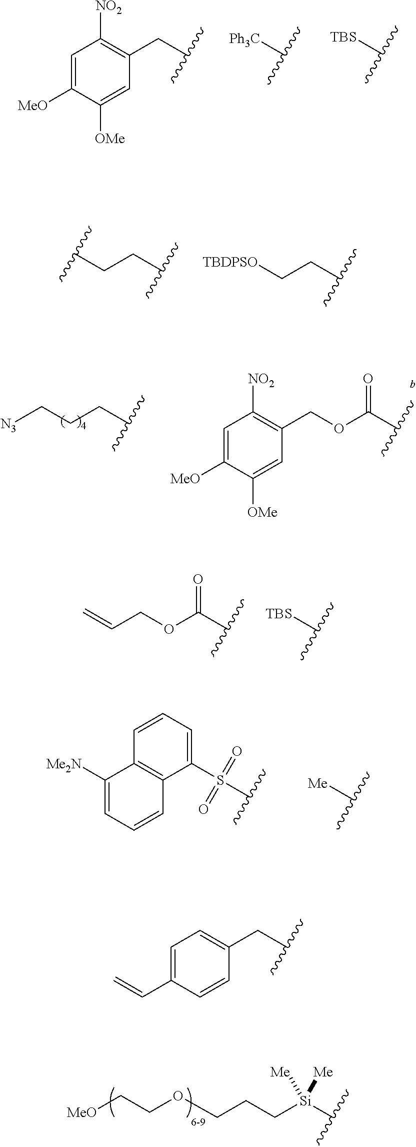

wherein TBS is tert-butyldimethylsiloxy and TBDPSO is tert-butyldiphenylsiloxy.

If the end-capping reagent generates acid biproduct, which occurs when acid chlorides are used, the reaction mixture must be neutralized to prevent premature degradation of the product polymer. After reaction with the end-capping compound, the reaction mixture can be combined with

saturated NaHCO₃(excess) and the biphasic mixture transferred to a separatory funnel. The organic phase can be washed with saturated NaHCO₃ and DI water before being dried under reduced pressure. Thus, in some embodiments, high yields are obtained without purification. Alternatively, the poly(phthalaldehyde) polymer can precipitated by adding the reaction mixture to a solution of cold methanol. If desired the precipitated polymer can be washed with a solid phase washing vessel by adding solvent and bubbling N2 through the solution at a vigorous rate. The washing steps may (e.g. sequentially include MeOH, MeOH, and hexanes. The resulting polymer can be dried under reduced pressure (4.5 mmHg) overnight.

The poly(phthalaldehydes) polymer typically comprises at least 50, 60, 70, 80, 90, 95 wt. % or greater of polymerized phthalaldehyde units. In some embodiments, the wt. % of polymerized polyol units is no greater than 25, 20, 15, 10, 5, 4, 3, 2, or 1 wt. % of the poly(phthalaldehydes) polymer. In some embodiments, the wt. % of polymerized polyol units is no greater than 25, 20, 15, 10, 5, 4, 3, 2, or 1 wt. % of the poly(phthalaldehydes) polymer.

The molecular weight (Mn) of the poly(phthalaldehyde) polymer can generally range from about 2,000 g/mole to 100,000 g/mole. The polydispersity typically ranges from about 1.1 to 2 or 3. For poly(phthalaldehyde) polymers that are utilized as crosslinkers, lower molecular weights are typically preferred. Thus, in some embodiments, the poly(phthalaldehyde) polymer has a molecular weight less than 25,000; 20,000; 15,000; 10,000 or 5,000 g/mole. In some embodiments, the molecular weight is at least 2,000; 4,000, or 5,000 g/mole. The molecular weight (Mn) can be determined by ¹H-NMR, osmometry or Gel Permeation Chromatography (GPC), as described in the forthcoming examples.

A polymerizable composition can be formed by combining the ethylenically unsaturated poly(phthalaldehyde) polymer with at least one other ethylenically unsaturated components, such as other (meth)acrylate monomers. The (meth)acrylate monomer may be a mono(meth)acrylate or multi(meth)acrylate having two or more (meth)acrylate groups. In some embodiments, the (meth)acrylate monomer comprises a cyclic group, such as a cycloaliphatic group. Monomers with cyclic group are typically high glass transition temperature (Tg) monomers. In some embodiments, a homopolymer of the other ethylenically unsaturated monomer(s) has a Tg of at least 50, 75, 100, 125, 150 or 175° C. In some embodiments, the Tg of the other ethylenically unsaturated monomer(s) is no greater than about 200° C. One representative (meth)acrylate monomer is tricyclodecanedimethanol diacrylate, reported to have a Tg of 186° C., as measured according to Dynamic Mechanical Analysis.

The ethylenically unsaturated poly(phthalaldehyde) polymer can be combined with other ethylenically unsaturated components at a weight ratio of 1:10 to 10:1. In some embodiments, the ethylenically unsaturated poly(phthalaldehyde) polymer is present in an amount equal to or greater than the amount of other ethylenically unsaturated components. In some embodiments, the weight ratio of ethylenically unsaturated poly(phthalaldehyde) polymer to other ethylenically unsaturated components is at least 1:1, 1.5:1, 2:1, 2.5:1, or 3:1.

Typically a free-radical initiator (e.g. photoinitiator) is added to the polymerizable composition.

The ethylenically unsaturated poly(phthalaldehyde) polymer alone or polymerizable composition comprising the ethylenically unsaturated poly(phthalaldehyde) polymer in combination with other ethylenically unsaturated components can be cured by exposure to actinic (e.g. ultraviolet) radiation. Suitable ethylenically unsaturated components include monofunctional (meth)acrylates such as 2-phenoxyethyl acrylate or tetrahydrofurfuryl acrylate and difunctional acrylates include 1,6-hexanediol diacrylate, tripropylene glycol diacrylate, or tricyclodecane dimethanol diacrylate, butanoic acid, triacrylates such as trimethylolpropane triacrylate or ethoxylated trimethylolpropane triacrylate, tetraacrylates such as ethoxylated pentaerythritol tetraacrylate, or higher functional acrylates such as dipentaerythritol pentaacrylate.

The cured poly(phthalaldehyde) polymer can have an onset degradation temperature of about 140° C. as determined by thermogravimetric analysis (TGA), as further described in the forthcoming examples. When a sufficient amount of poly(phthalaldehyde) polymer is combined with other ethylenically unsaturated components, the cured polymerizable composition comprising such can also have an onset degradation temperature in the same range as the cured poly(phthalaldehyde) polymer. Comonomers can raise onset temperature to a temperature up to 150, 160, 170, 180, 190 or 200° C.

The cured poly(phthalaldehyde) polymer or cured polymerizable composition comprising such can have a mass loss of at least 50% at a temperature ranging from 150° C. to 200° C., as determined by TGA. In some embodiments, the mass loss is 90% or greater at a temperature less than 250° C. In some embodiments, the mass loss of the cured polymerizable composition at a temperature less than 250° C. is limited by the presence of the other ethylenically unsaturated component. For example, if the polymerizable composition comprises 25 wt. % of a cured ethylenically unsaturated monomer that does not depolymerize at a temperature less than 250° C., the mass loss at 250° C. of the cured polymerizable composition is about 75%.

The invention is further illustrated by the following non-limiting examples.

### EXAMPLES

Unless otherwise noted or apparent from the context, all parts, percentages, ratios, etc. in the Examples and the rest of the specification are by weight. Table 1, below, lists materials used in the examples and their sources.

TABLE 1
Table of materials, abbreviations, and sources.

| Abbre- | | |
|---|---|---|
| viation | Description | Source |
| o-PA | Ortho-phthaldialdehyde, | Available from Alfa |
| | 98% | Aesar, Ward Hill, |
| | | Massachusetts |
| Diethylene | 99% | Available from Alfa |
| glycol | | Aesar, Ward Hill, |
| | | Massachusetts |
| P1 Base | tert-Butylimino- | Available from Sigma- |
| | tri(pyrrolidino)phos- | Aldrich Co. LLC., St. |
| | phorane, ≥97% depicted | Louis, Missouri |
| | in Example 5 | |
| Methacryloyl | purum, dist., ≥97.0%, | Available from Sigma- |
| Chloride | contains ~0.02% 2,6-di- | Aldrich Co. LLC., St. |
| | tert-butyl-4-methylphenol | Louis, Missouri |
| | as stabilizer | |
| IEM | 2-(Methacryloyloxy)ethyl | Available from Sigma- |
| | isocyanate, 98%, | Aldrich Co. LLC., St. |
| | contains ≤0.1% BHT (Butylated | Louis, Missouri |
| | hydroxytoluene) as inhibitor | |
| DCM | Dichloromethane | Available under the |
| | | trade designation |
| | | OMNISOLV from EMD |
| | | Millipore, Burlington |
| | | Massachusetts. |
| CaH₂ | Calcium hydride, reagent | Available from Sigma- |
| | grade, 95% | Aldrich Co. LLC., St. |
| | | Louis, Missouri |
| Toluene | Anhydrous, >99.8% | Available from Sigma- |
| | | Aldrich Co. LLC., St. |
| | | Louis, Missouri. |
| THF | Tetrahydrofuran, | Available from Sigma- |
| | anhydrous, ≥99.9%, | Aldrich Co. LLC., St. |
| | inhibitor-free | Louis, Missouri. |
| Methanol | vendor product code MX0480-6 | Omnisolv, available |
| | | from EMD Millipore |
| Acetone | vendor product code 58019 | Omnisolv, available |
| | | from EMD Millipore |
| Glycerol | 99+% | Available from Fisher |
| | | Scientific |
| Ethyl | ~50% solution in toluene | Available from Fisher |
| glyoxylate | | Scientific |
| Molecular | 4 Angstrom | Available from Sigma- |
| Sieves | | Aldrich Co. LLC., St. |
| | | Louis, Missouri. |
| P₂O5 | Phosphorous (V) oxide | Thermo Fisher |
| Methacrylic | With Toponal A as inhibitor, | Millipore Sigma |
| anhydride | 94% | |
| SR833 S | Tricyclodecanedimethanol | Obtained from Sartomer |
| | diacrylate | (Arkema Group), Exton, |
| | | Pennsylvania |
| TPO | Diphenyl(2,4,6- | Obtained from IGM |
| | trimethylbenzoyl)phosphine | Resins, Charlotte, |
| | oxide | North Carolina |

### Examples

### Reagent Drying

Diethylene glycol was stirred over CaH₂ for 12 hours prior to degassing with three freeze-pump-thaw cycles and vacuum distillation. o-PA was purified by recrystallization from dry, degassed DCM/hexanes by layering a DCM solution (˜50 g in 50 mL) with hexanes (˜200 mL). Both methacryloyl chloride and IEM were vacuum distilled immediately prior to use.

All other chemicals were used as received.

### Test Methods

### Gel Permeation Chromatography (GPC)

The GPC equipment consisted of a 1260 Infinity LC (comprised of quaternary pump, autosampler, column compartment and diode array detector) from Agilent Technologies (Santa Clara, California, United States of America) operated at a flow rate of 1.0 mL/min. The GPC column set was comprised of a PLgel MIXED-A (300 mm length×7.5 mm internal diameter) plus a PLgel MIXED-B (300 mm length×7.5 mm internal diameter) both from Agilent Technologies. The detection consisted of a DAWN HELEOS II 18 angle Light Scattering detector, a VISCOSTAR viscometer and an OPTILAB T-rEX differential refractive index detector, all 3 from Wyatt Technology Corporation (Santa Barbara, California, United States). Data were collected and analyzed using software ASTRA version 6 from Wyatt Technology Corporation. The column compartment, viscometer and differential refractive index detector were set to 40° C.

The solvent and eluent (or mobile phase) consisted of tetrahydrofuran (stabilized with 250 parts per million of butylated hydroxytoluene) OMNISOLV grade modified with 5% v/v triethylamine (both from EMD Millipore Corporation, Burlington, Massachusetts).

### Nuclear Magnetic Resonance (NMR)

A portion of the polymer sample was analyzed as a solution of unknown concentration (generally approximately 12 mg/mL) in CDCl₃. NMR spectra were acquired on a Bruker AVANCE 600 MHz NMR spectrometer equipped with an inverse cryoprobe.

### Thermogravimetric Analysis (TGA)

The samples were analyzed using a TGA5500 (TA Instruments, New Castle, DE). The sample chamber was purged with nitrogen gas and the samples were heated at a rate of 10° C./min to 140° C., then at 2° C./min to 200° C., then at 10° C./min to 300° C.

### Example 1

Anionic polymerization of PPA-methacrylate from a difunctional initiator (diethylene glycol), o-PA, and methacryloyl chloride.

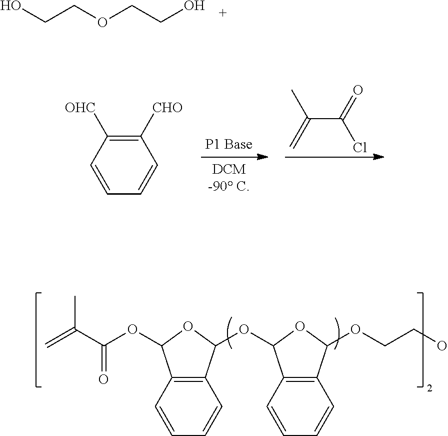

o-PA (10.0 g, 74.6 mmol), diethylene glycol (153 μL, 161 mg, 3.23 mmol —OH) and DCM (190 mL) were combined in a 500 mL Schlenk flask equipped with stirbar. P1 base (1.0 mL, 3.27 mmol) was diluted with 4 mL DCM and loaded into a syringe. The reaction flask was sealed with a rubber septum and attached to a Schlenk line before being cooled to −90° C. using a N₂/methanol bath while under positive Ar atmosphere. Once cooled, P1 base was added via syringe and the polymerization allowed to proceed at −90° C. for 30 minutes. The polymerization was then terminated by adding methacryloyl chloride (3 mL, excess) and the reaction was allowed to stir at −90° C. for 1 hour before being allowed to slowly warm to room temperature over the course of 4 hours. Once at room temperature, saturated NaHCO₃ was added (100 mL, excess) and the biphasic mixture transferred to a separatory funnel. The organic phase was washed with saturated NaHCO₃ (2×100 mL) and DI water (1×100 mL) before being dried under reduced pressure. The pale-yellow solid was then redissolved in minimal THF (˜25 mL) and precipitated from methanol (250 mL). An off-white solid was collected by filtration and reprecipitated from THE/methanol. 8.64 g (86% isolated yield) were obtained after filtration and drying. End group analysis by NMR indicated a Mₙ of ˜5200 g/mol. The polymer was analyzed by TGA. The onset of degradation (range) was at 140° C. and the mass loss at 250° C. was 94.3%.

### Example 2

Anionic polymerization of PPA-methacrylate from a difunctional initiator (diethylene glycol), o-PA, and 2-isocyanato-ethoxymethacrylate (IEM).

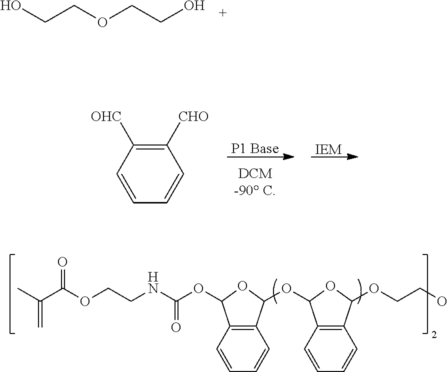

o-PA (10.0 g, 74.6 mmol), diethylene glycol (153 μL, 161 mg, 3.23 mmol-OH) and DCM (190 mL) were combined in a 500 mL Schlenk flask equipped with stirbar. P1 base (1.0 mL, 3.27 mmol) was diluted with 4 mL DCM and loaded into a syringe. The reaction flask was sealed with a rubber septum and attached to a Schlenk line before being cooled to −90° C. using a N₂/methanol bath while under positive Ar atmosphere. Once cooled, P1 base was added via syringe and the polymerization allowed to proceed at −90° C. for 30 minutes. The polymerization was then terminated by adding IEM (3 mL diluted in 5 mL DCM, excess) and the reaction was allowed to stir at −90° C. for 1 hour before being allowed to slowly warm to room temperature over the course of 4 hours. Once at room temperature, saturated NaHCO₃ was added (100 mL, excess) and the biphasic mixture transferred to a separatory funnel. The organic phase was washed with saturated NaHCO₃ (2×100 mL) and DI water (1×100 mL) before being dried under reduced pressure. The pale-yellow solid was then redissolved in minimal THF (˜25 mL) and precipitated from methanol (250 mL). An off-white solid was collected by filtration and reprecipitated from THE/methanol. 7.84 g (77% isolated yield) were obtained after filtration and drying. End group analysis by NMR indicated a Mₙ of ˜8000 g/mol.

### Example 3

Anionic polymerization of PPA-methacrylate from a difunctional initiator (diethylene glycol), o-PA, and methacrylic anhydride.

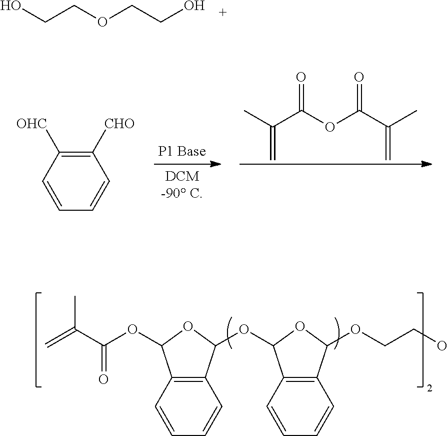

o-PA (10.0 g, 74.6 mmol), diethylene glycol (95 μL, 106 mg, 2.0 mmol —OH) and DCM (190 mL) were combined in a 500 mL Schlenk flask equipped with stirbar. P1 base (0.62 mL, 2.0 mmol) was diluted with 4 mL DCM and loaded into a syringe. The reaction flask was sealed with a rubber septum and attached to a Schlenk line before being cooled to −90° C. using a N₂/methanol bath while under positive Ar atmosphere. Once cooled, P1 base was added via syringe and the polymerization allowed to proceed at −90° C. for 30 minutes. The polymerization was then terminated by adding methacrylic anhydride (3 mL diluted in 5 mL DCM, excess) and the reaction was allowed to stir at −90° C. for 1 hour before being allowed to slowly warm to room temperature over the course of 4 hours. Once at room temperature, saturated NaHCO₃ was added (100 mL, excess) and the biphasic mixture transferred to a separatory funnel. The organic phase was washed with saturated NaHCO₃ (2×100 mL) and DI water (1×100 mL) before being dried under reduced pressure. The pale-yellow solid was then redissolved in minimal THF (˜25 mL) and precipitated from methanol (250 mL). An off-white solid was collected by filtration and reprecipitated from THF/methanol. NMR analysis of the obtained solid showed a 20% yield. End group analysis by NMR indicated a Mₙ of ˜7400 g/mol

### Example 4

Anionic polymerization of PPA-methacrylate from a difunctional initiator (diethylene glycol), o-PA, ethyl glyoxylate, and 2-isocyanato-ethoxymethacrylate (IEM).

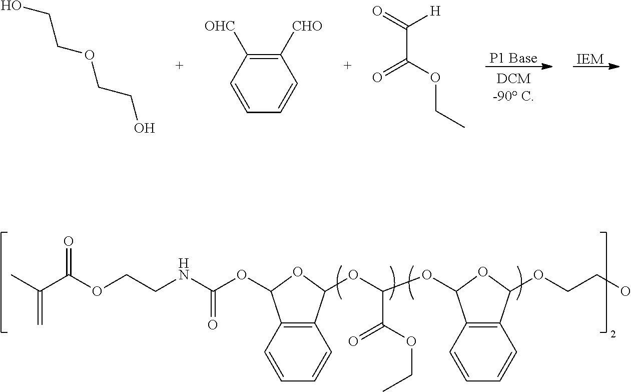

In a glovebox to a dry 250 mL round bottom flask equipped with a stir bar was added 2.5 g ortho-phthaldialdehyde (18.6 mmol, 25 equivalents), 1.9 g ethyl glyoxylate (18.6 mmol, 25 equivalents), and 124 g dichloromethane before sealing with a septum, removing from the glovebox, and cooling in a dry ice acetone bath for 1 hour before initiating the reaction. A gastight syringe was charged with 79.1 mg diethylene glycol (746 micromole (μmol), 1 equivalent) in the glovebox before removing and adding to the reactant solution. A second gastight syringe was charged with 477 mg P1-base (1.53 mmol, 2.05 equivalents) before removing from the glovebox and adding rapidly to the reactant solution and the reaction was allowed to proceed for 2 hours at −78° C. A third gastight syringe was charged with 1.50 g IEM (9.67 mmol, 13 equivalents) in a glovebox before removing and rapidly adding to the reactant solution. The reactant solution was allowed to slowly warm to room temperature by gradual removal from the dry ice acetone bath over the course of 2 hours before concentrating to a viscous resinous yellow oil via rotovap. The crude reactant solution was taken up in 25 mL commercially pure dichloromethane and precipitated into 200 mL methanol. The yellow milky suspension was allowed to stand overnight after which the supernatant had mostly clarified and the polymer had congealed to a viscous yellow oil at the bottom of the flask. The supernatant was decanted and the precipitation process repeated once more before decanting and drying the polymer under an air sparge for 3 days using a 40° C. water bath to give 2.97 g of poly(pthalaldehyde)-co-poly(ethyl glyoxylate)-α,ω-urethane acrylate as a viscous yellow oil in 63% yield. Analysis of the molecular weight by GPC indicated an Mₙ of 5.1 kDa and an M_{w} of 6.1 kDa.

### Example 5

Anionic polymerization of PPA-methacrylate from a trifunctional initiator (glycerol), o-PA, and 2-isocyanato-ethoxymethacrylate (IEM).

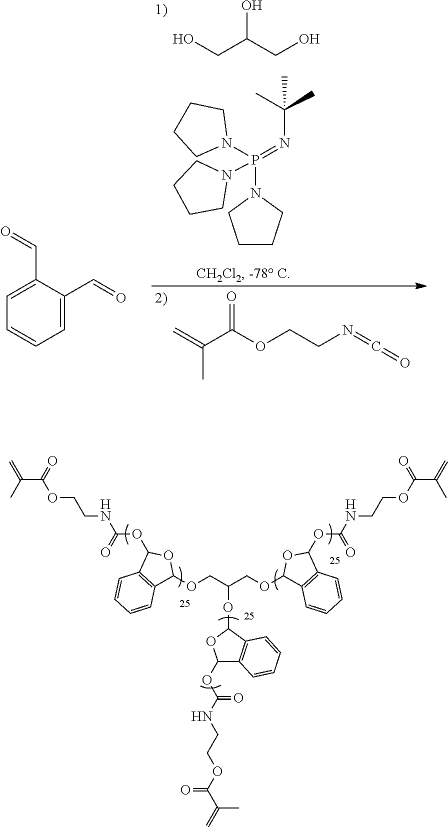

In a glovebox to a dry 250 mL round bottom flask equipped with a stir bar was added 5 g o-PA (37.3 mmol, 75 equivalents) and 124 g dichloromethane before sealing with a septum, removing from the glovebox, and cooling in a dry ice acetone bath under positive nitrogen atmosphere for 1 hour before initiating. In a glovebox a gastight syringe was charged with 45.8 mg glycerol (497 μmol, 1 equivalent) before removing from the glovebox and adding to the reactant solution. In a glovebox a second gastight syringe was charged with 474 mg P1 base (16.3 mmol, 3.05 equivalents) before removing from the glovebox and adding rapidly to the reactant solution and the reaction was allowed to proceed at −78° C. for 2 hours. In a glovebox a third gastight syringe was charged with 1.50 g IEM (9.67 mmol, 13 equivalents) which was rapidly added to the reactant solution. The reactant solution was allowed to warm to room temperature over the course of 2 hours by gradually removing from the dry ice acetone bath. The reactant solution was then concentrated via rotovap to give a pale yellow resinous foamy viscoelastic solid which was dissolved in 25 mL commercially pure dichloromethane and precipitated into 200 mL commercially pure methanol before collecting the precipitate by filtration and the precipitation process was repeated once more to give 5.13 g of off-white solid in 97% yield. Analysis of the molecular weight by GPC indicated an Mₙ of 30.0 kDa and an M_{w} of 48.0 kDa.

### Example 5—Coating Composition Containing the PPA-Methacrylate of Example 1

Glass slide preparation: Glass microscope slides (2.5 cm×7.5 cm) were cleaned by exposure to oxygen plasma for 10 minutes. A solution was prepared by mixing acrylate silane oligomer (Shin Etsu KR-513, 400 mg), absolute ethanol (18.52 g), water (1.0 g), and acetic acid (80 mg). The glass slides were immersed in this solution for 30 minutes, then rinsed with excess absolute ethanol. The slides were then placed in an oven held at 70° C. for 30 minutes.

Coating preparation: PPA-methacrylate of Example 1, SR833 S, and TPO were each dissolved in propylene glycol monomethyl ether acetate (PGMEA) at 10% by weight. In a vial was mixed 0.75 g of PPA-methacrylate solution, 0.25 g of SR833 S solution, and 20 mg of TPO solution. This mixture solution (1.0 mL) was drop coated on a glass slide, and the solvent was evaporated by placing the slide in an oven held at 70° C. for 10 minutes. The coating was cured with a high intensity UV lamp using a benchtop conveyor system available from Heraeus, Inc. The system was purged with nitrogen gas, and the coatings were cured using a D bulb at 100% power while running the conveyor belt at 30 feet per minute. The coatings were passed through the system three times.

A sample of the cured coating was scraped off the glass slide using a razor blade and analyzed by thermogravimetric analysis (TGA). The onset of degradation was at 140° C., and the mass loss at 200° C. was 68.8%.

1. A poly(phthaladialdehyde) polymer comprising the reaction product of:
an intermediate comprising the reaction product of phthaladialdehyde and a polyol; and
an end-capping compound comprising an ethylenically unsaturated group.

2. The poly(phthaladialdehyde) polymer of claim 1 wherein the polymer comprises one or more ethylenically unsaturated groups.

3. The poly(phthaladialdehyde) polymer of claim 1 wherein the polymer averages at least two ethylenically unsaturated groups.

4. The poly(phthaladialdehyde) polymer of claim 1 wherein the polymer averages at least three ethylenically unsaturated groups.

5. The poly(phthaladialdehyde) polymer of claim 1 wherein the ethylenically unsaturated group is a (meth)acrylate group.

6. The poly(phthaladialdehyde) polymer of claim 1 wherein the end-capping compound comprises methacryloyl chloride, a methacryloyl isocyanate, an acid anhydride, or a combination thereof.

7. The poly(phthaladialdehyde) polymer of claim 1 wherein reaction product further comprises a second end-capping compound lacking an ethylenically unsaturated.

8. The poly(phthaladialdehyde) polymer of claim 1 wherein the reaction product further comprises a second aldehyde that is different than phthaladialdehyde.

9. The poly(phthaladialdehyde) polymer of claim 1 wherein the polymer comprises at least 50, 60, 70, 80, or 90 or more wt. % of polymerized phthaladialdehyde units.

10. The poly(phthaladialdehyde) polymer of claim 1 wherein polymer has a number average molecular weight ranging from 2000 g/mole to 25,000 g/mole.

11. A poly(phthaladialdehyde) polymer having the formula:
R³[PPA-L¹-R¹]ₙ
wherein R³ is a residue of a polyol;
PPA is poly(phthaladialdehyde);
L¹ is independently a covalent bond or a linking group:
n is at least 2; and
R¹ is independently an end group such at least two R¹ groups are ethylenically unsaturated groups.

12. A poly(phthaladialdehyde) polymer having the formula:
R³-[PPA/A²-L¹-R¹]ₙ
wherein R³ is a residue of a polyol;
PPA/A² is a copolymer of phthaladialdehyde and a second different aldehyde;
L¹ is independently a covalent bond or a linking group:
n is at least 1; and
R¹ is independently an end group such one or more R¹ groups are ethylenically unsaturated groups.

13. (canceled)

14. A composition comprises the poly(phthaladialdehyde) polymer of claim 1 wherein the ethylenically unsaturated groups are cured.

15. A polymerizable composition comprising the poly(phthaladialdehyde) polymer of claim 1 and at least one other ethylenically unsaturated component.

16. A composition comprises the polymerizable composition of claim 15 wherein the ethylenically unsaturated groups are cured.

17. The composition of claim 14 wherein the composition has one or more of the following properties as determined by thermal gravimetric analysis:
an onset temperature of degradation in a range from 140° C. to 200° C.;
a mass loss of at least 50% at 200° C.; or
a mass loss of at least 90% at a temperature in the range of 200° C. to 250° C.

18. A method of making poly(phthaladialdehyde) polymer comprising:
anionic polymerizing phthaldialdehyde with a polyol to provide an intermediate having the formula 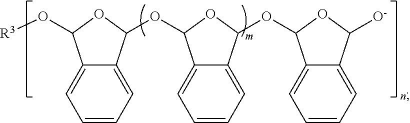
and
reacting the oxygen anion with an end-capping compound comprising an electrophilic group and an ethylenically unsaturated group.

19. The method of claim 18 wherein the method further comprises a second aldehyde and the intermediate comprises a copolymer of phthaldialdehyde and the second aldehyde.

20. (canceled)
